(19) United States
(12) Patent Application Publication
(10) Pub. No.: US 2002/0059332 A1
(43) Pub. Date: May 16, 2002

(54) System and method for memory management

(76) Inventors: Jochen Kappel, Vence (FR); Josef Markgraf, Goldbach (DE); Michael Meadows, Sundbyberg (SE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/825,438

(22) Filed: Apr. 2, 2001

Related U.S. Application Data
(60) Provisional application No. 60/193,422, filed on Mar. 31, 2000.

(30) Foreign Application Priority Data
Mar. 31, 2000 (DE) 00106948.3-2201

(51) Int. Cl. G06F 15/16

(52) U.S. Cl. 707/206; 709/203

(57) ABSTRACT

The present invention provides a system and method for providing memory management. In architecture, the system includes a first object to perform a service and a transaction context created for the first object to track all referenced objects. A modifier modifies the transaction context each time a next object is referenced. The present invention can also be viewed as a method for providing memory management. The method operates by acquiring a first object to perform a service and creating a transaction context to track all referenced objects. Then the transaction context is modified each time a next object is referenced.

### CLAIM OF PRIORITY AND CROSS REFERENCE TO RELATED APPLICATIONS

This application claims the benefit of U.S. Provisional Patent Application entitled “Targys System,” filed Mar. 31, 2000 and having Ser. No. 60/193,422, and copending U.S. Utility patent application entitled, “Customer Care and Billing System,” having attorney docket no. 51207-1070, filed on Mar. 28, 2001, which also claims priority to German Patent Application No. 00106948.3-2201, entitled “Customer Care and Billing System,” filed Mar. 31, 2000, all of the foregoing of which are now pending and are incorporated herein by reference.

### FIELD OF THE INVENTION

The present invention generally relates to computers and computer software, and more particularly, to a system and method for memory management.

### DESCRIPTION OF RELATED ART

In order to be able to respond to frequent changes in the telecommunications industry, any system needs to be highly flexible and scalable. The systems also have to be able to be quickly and easily configured and adapt the software to meet various demands without extensive programming efforts to implement such changes.

To ensure interoperability with other systems and allowing programming language independent implementations, a common object request broker architecture (“CORBA”) is one system chosen to be used as a basis for communication between components within an application server. CORBA specifies that a system provides interoperability between objects in a heterogeneous, distributed environment in a manner that is transparent to the programmer. CORBA is one such broker architecture that enables applications to communicate with one another no matter where they are located.

However, there are instances when CORBA does not provide complete heterogeneous communication. The use of CORBA severely reduces the ability for current memory management systems to operate in an object oriented system. Currently, all object instances that are public to CORBA must explicitly be deleted, otherwise CORBA will hold onto them and any garbage collector will not collect the instances. In addition to this, the object identifying facilities of some software forces a client server to explicitly deallocate objects from cache as well as the CORBA. This obviously causes a problem in that a computer system is then unable to keep the level of memory consumption as low as possible. Considering the amount of data that a typical client server may process, it is easy for the server to run out of memory and crash, unless object instances that are no longer being used are deallocated.

Another shortcoming is that memory management can be a tricky business, and therefore it is easy to make mistakes or simply forget about freeing memory. Therefore, the use of CORBA has caused the task of memory management to be dealt with by the server programs, and thus, because of the tricky nature of memory management, makes it difficult to ensure that the computer system is using the minimum amount of memory.

Thus, a heretofore-unaddressed need exists in the industry to address the aforementioned and/or other deficiencies and inadequacies.

### SUMMARY OF THE INVENTION

The present invention provides a system and method for performing memory management. Briefly described, in architecture, the system of the preferred embodiment can be implemented as follows. The system includes a first object to perform a service and a transaction context created for the first object to track all referenced objects. A modifier modifies the transaction context each time a next object is referenced.

The present invention can also be viewed as providing a method for providing memory management system. In this regard, the preferred method can be broadly summarized by the following steps. The method operates by: 1) acquiring a first object to perform a service; 2) creating a transaction context to track all referenced objects; and 3) modifying the transaction context each time a next object is referenced.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. Moreover, in the drawings, like reference numerals designate corresponding parts throughout the several views.

FIG. 1 is a block diagram illustrating an example of a network in which the memory management system and method of the present invention may be implemented.

FIG. 2 is a block diagram illustrating an example of a computer system utilizing clients and servers that use the memory management system and method of the present invention.

FIG. 2 is a block diagram illustrating an example of the technical architecture of clients and servers that use the memory management system and method of the present invention, as illustrated in FIG. 1.

FIG. 3 is a block diagram illustrating an example of a computer system utilizing clients and servers that use the memory management system and method of the present invention.

FIG. 4 is a data flow diagram illustrating an example of the process flow of the memory management system of the present invention, as illustrated in FIGS. 2, and 3.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

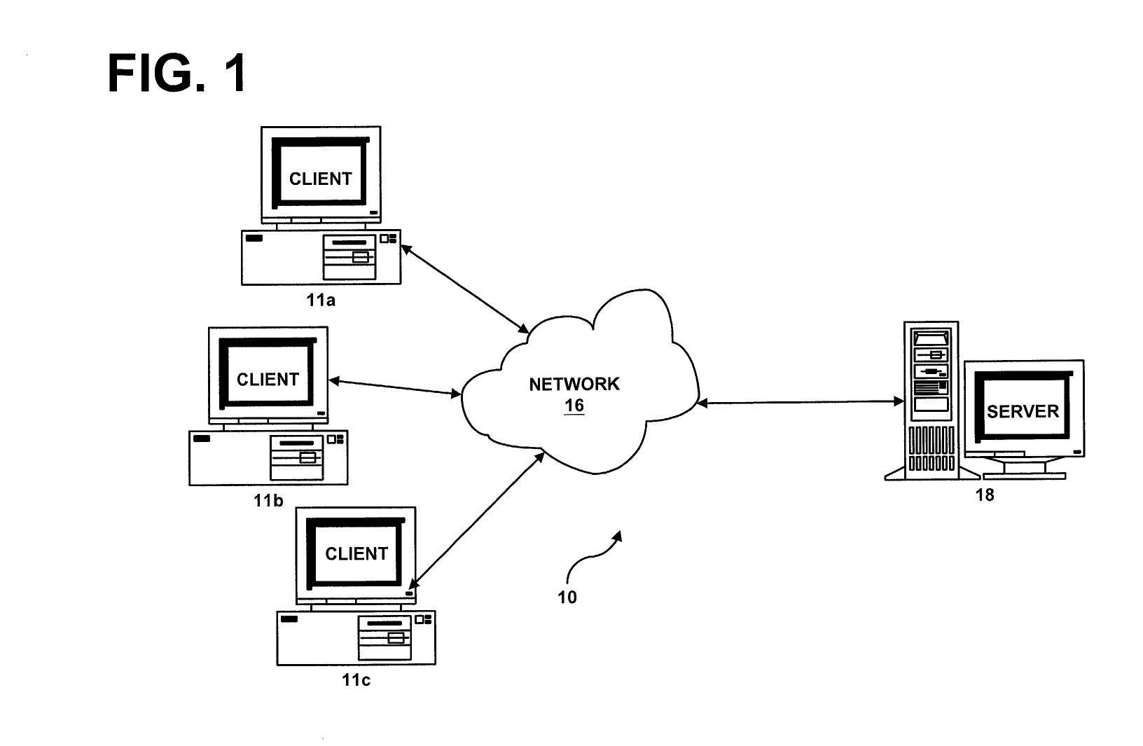

Referring now to the drawings, wherein like reference numerals designate corresponding parts throughout the drawings, FIG. 1 is a block diagram that portrays a diagram of a network that illustrates the flexibility, expandability, and platform independence in which the present memory management system may be implemented. Referring to FIG. 1, a series of client computers 11a, 11b, 11c are connected to a server computer 18 via a network 16. The network 16 may be, for example, but is not limited to, a dial-in network, local area network (LAN), wide area network (WAN), public switched telephone network (PSTN), Intranet, Internet, Ethernet type networks, and the like. The client computers 11a, 11b, 11c (hereinafter, 11) may be located within a LAN, WAN, PSTN, Intranet, Internet, Ethernet type networks, or the like. It should be noted that the number of client computers and server computers may differ from the number presently illustrated.

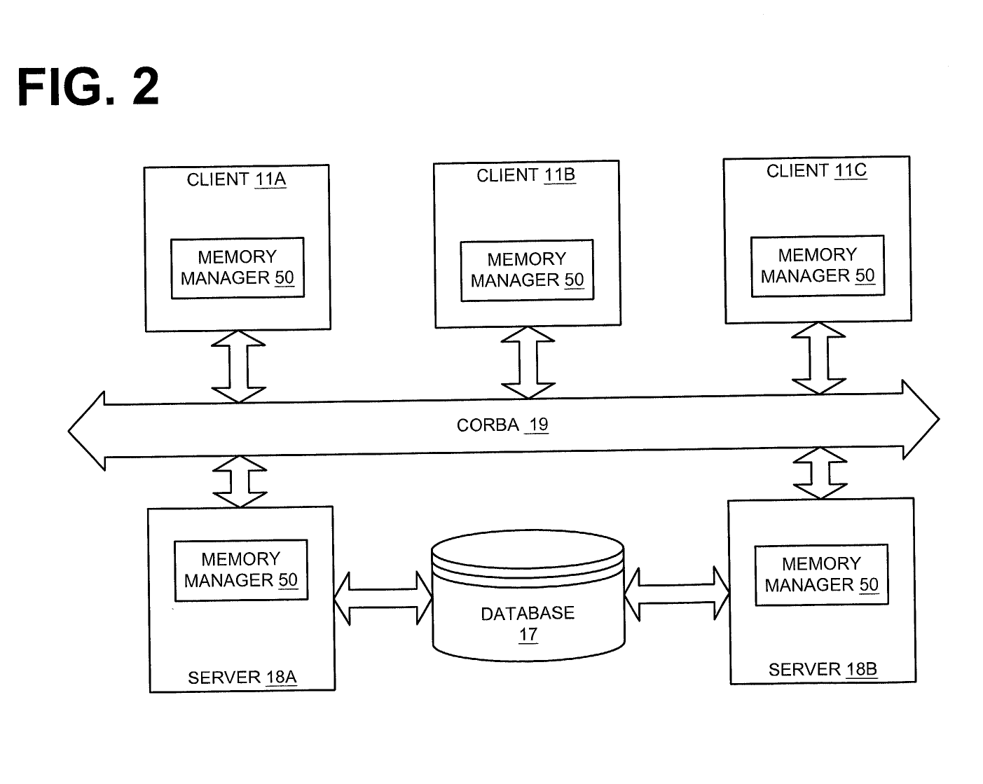

FIG. 2 is a block diagram illustrating an example of the technical architecture of clients and servers that use the memory management system and method of the present invention, as illustrated in FIG. 1. As shown, each client 11 and server 18 utilizes a memory manager 50 for both created or invoked objects. The memory manager 50 enables each object created or invoked to track all the additional objects that are referenced by the invoked or created object. It is appreciated that objects can be invoked or created within the client 11 or within the server 18 utilizing the CORBA framework 19.

Generally, the server 18 can only be accessed through a CORBA 19 interface. CORBA is a common object request broker architecture that specifies a system providing interoperability between objects and a heterogeneous, distributed environment in a manner transparent to the programmer. CORBA allows applications to communicate with each other no matter where they are located. Utilizing CORBA 19, the clients 11 can communicate and obtain services from the server 18 by invoking objects. Server 18A can provide services by creating or invoking objects in the server 18A or in a remote server 18B. Invocation of an object on a remote server 18B is also required to be performed through the CORBA 19 interface. The use of CORBA in the technical foundation of providing services severely reduces the utility of other environment memory management. Since all object instances are public in CORBA, they must therefore be explicitly deleted, or CORBA will hold onto the objects and any garbage collector will not collect the instances. This creates a need for explicit memory management in the use of CORBA.

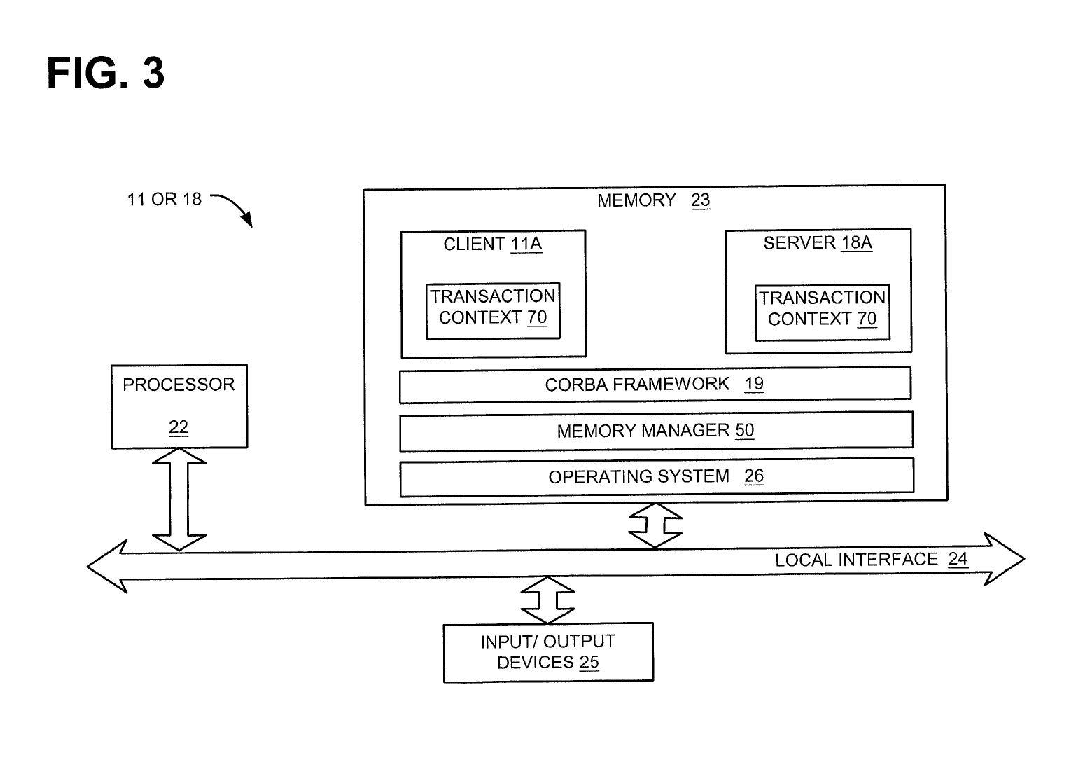

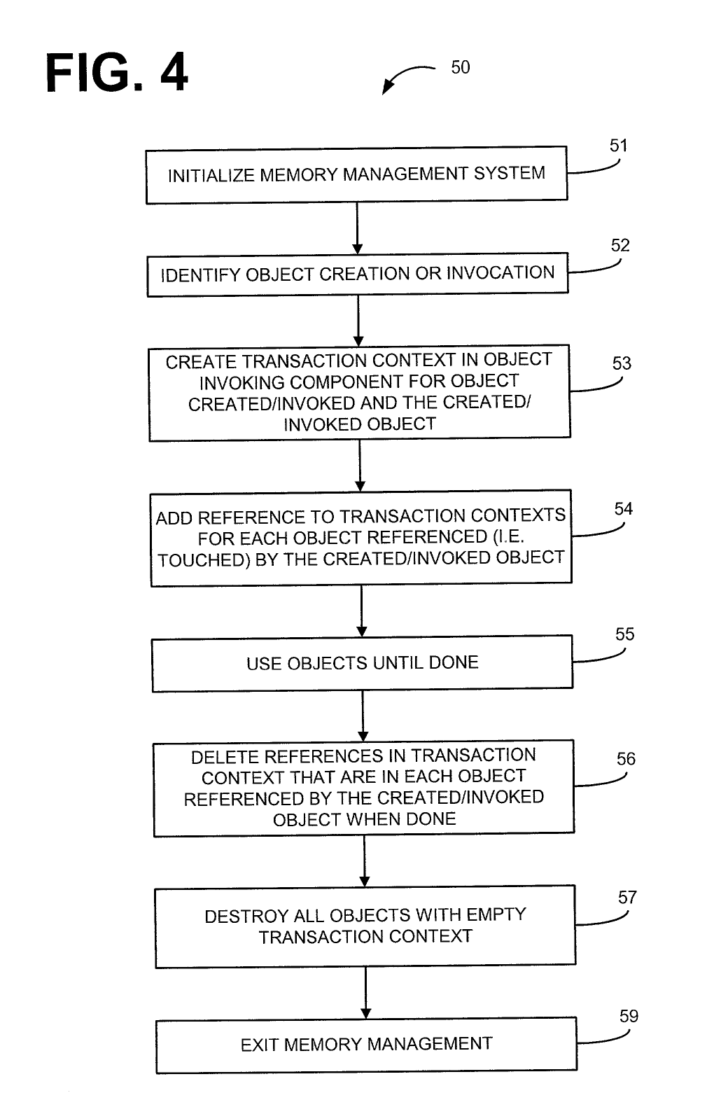

When an object instance is made public using CORBA, unless it is acceptable across the network, CORBA itself maintains information about the instance. Therefore, CORBA instances should be explicitly deleted from CORBA. In the simplest cases, memory management deletes object instances from CORBA that are no longer referenced. The immediate question is how to determine when an object is no longer referenced. In most extreme cases, a client or other accessing object informs the object in question when it is no longer needed. However, this would leave the responsibility for memory management in the hands of all accessing code, such as all CORBA clients (real clients and other accessing objects from the servers). The present invention corrects this shortcoming by utilizing a transaction context that is created in either the client or server. The transaction context is herein defined in further detail with regard to FIGS. 3 and 4.

An example of a general-purpose computer that can implement the memory management system of the present invention is shown in FIG. 3. The memory management system or “memory manager” is denoted by reference numeral 50. The memory management system 50 of the invention can be implemented in software (e.g., firmware), hardware, or a combination thereof. In one embodiment, the memory management system 50 is implemented in software, as an executable program, and is executed by a special or general purpose digital computer, such as a personal computer (PC; IBM-compatible, Apple-compatible, or otherwise), workstation, minicomputer, personal digital assistant (PDA) or mainframe computer.

Generally, in terms of hardware architecture, as shown in FIG. 3, the computer 11 or 18 includes a processor 22, memory 23, and one or more input and/or output (I/O) devices 25 (or peripherals) that are communicatively coupled via a local interface 24. The local interface 24 can be, for example but not limited to, one or more buses or other wired or wireless connections, as is known in the art. The local interface 24 may have additional elements, which are omitted for simplicity, such as controllers, buffers (caches), drivers, repeaters, and receivers, to enable communications. Further, the local interface 24 may include address, control, and/or data connections to enable appropriate communications among the aforementioned components.

The processor 22 is a hardware device for executing software that can be stored in memory 23. The processor 22 can be virtually any custom made or commercially available processor, a central processing unit (CPU) or an auxiliary processor among several processors associated with the computer 11 or 18, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 23 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 23 may incorporate electronic, magnetic, optical, and/or other types of storage media. Note that the memory 23 can have a distributed architecture, where various components are situated remote from one another, but can be accessed by the processor 22.

The software in memory 23 may include one or more separate programs, each of which comprises an ordered listing of executable instructions for implementing logical functions. In the example of FIG. 3, the software in the memory 23 includes the memory management system 50, CORBA framework 19 and a suitable operating system (O/S) 26.

A non-exhaustive list of examples of suitable commercially available operating systems 26 is as follows: a Windows operating system from Microsoft Corporation, U.S.A., a Netware operating system available from Novell, Inc., U.S.A., an operating system available from IBM, Inc., U.S.A., any LINUX operating system available from many vendors or a UNIX operating system, which is available for purchase from many vendors, such as Hewlett-Packard Company, U.S.A., Sun Microsystems, Inc. and AT&T Corporation, U.S.A. The operating system 26 essentially controls the execution of other computer programs, such as the memory management system 50, and provides scheduling, input-output control, file and data management, memory management, and communication control and related services.

The memory management system 50 may be a source program, executable program (object code), script, or any other entity comprising a set of instructions to be performed. When a source program, then the program is usually translated via a compiler, assembler, interpreter, or the like, which may or may not be included within the memory 23, so as to operate properly in connection with the O/S 26. Furthermore, the memory management system 50 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, and Ada.

The I/O devices 25 may include input devices, for example but not limited to, a keyboard, mouse, scanner, microphone, etc. Furthermore, the I/O devices 25 may also include output devices, for example but not limited to, a printer, display, etc. Finally, the I/O devices 25 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11 or 18, is a PC, workstation, or the like, the software in the memory 23 may further include a basic input output system (BIOS) (omitted for simplicity). The BIOS is a set of essential software routines that initialize and test hardware at startup, start the O/S 26, and support the transfer of data among the hardware devices. The BIOS is stored in ROM so that the BIOS can be executed when the computer 11 or 18 is activated.

When the computer 11 or 18 is in operation, the processor 22 is configured to execute software stored within the memory 23, to communicate data to and from the memory 23, and to generally control operations of the computer 11 or 18 pursuant to the software. The memory management system 50 and the O/S 26 are read, in whole or in part, by the processor 22, perhaps buffered within the processor 22, and then executed.

When the memory management system 50 is implemented in software, as is shown in FIG. 3, it should be noted that the memory management system 50 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The memory management system 50 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the memory management system 50 is implemented in hardware, the memory management system 50 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 4 is a data flow diagram illustrating an example of the process flow of the memory management system 50 of the present invention. The memory management system 50 of the present invention utilizes a transaction context to track all objects invoked or created by a client and server, and any objects that the invoked or created object references or touches. The transaction context acts as a container for object interaction, i.e., objects are always created, read, updated and deleted within a transaction context. This provides a client or server unit with a defined life span, when the transaction context is over or “dead,” then it is known that the client or server that created the transaction context is through with the objects referenced. The transaction context may last a long time and most often an object will be used only at certain points within the lifetime. Thus, the destruction of objects can be performed when the transaction context is destroyed for an invoked or created object by a client or server. As the client or server must delete the transaction contents, such behavior can be controlled and, therefore, would not be the responsibility of application programmers.

One element of the memory management system 50 of the present invention is that each logged in client and server maintains a list of referenced objects. One implementation of an actual construction is that each client or server has an instance of an application root class, which contains a list of all open transaction context instances, where each of these transaction context instances contains a list of all touched objects.

First, the memory management system 50 is initialized upon the creation or invocation of the object on either a client 11 or server 18. At step 52, the memory management system identifies the object to be created or invoked. At step 53, the memory management system 50 then creates a transaction context in the object invoking component for the object created and in the created or invoked object. The transaction context in the invoking component is utilized to track all of the objects that are referenced or touched by the created or invoked object. The transaction context created in the actual or invoked or created object is utilized to track any objects that are referenced by the created or invoked objects.

For example, if the client 11 component invokes an object, then the reference to the invoked object is recorded in a transaction context for the invoking client. The memory management system 50 also creates a transaction context in the object created to therefore identify any objects that the created object would invoke or create. It is in this way that the transaction context creates a chain for all objects referenced or touched so that upon completion of the required service, all unreferenced objects can be deleted from memory.

At step 54, the memory management system 50 then adds the reference to the transaction context for each object referenced by the created object. At step 55, the memory management system 50 then waits until the objects being used are done. Upon completion of a performance of an object, the memory management system then deletes the references in the transaction context that are in each object referenced by the created or invoked object when the created or invoked object is done. Thus, when an object is destroyed, i.e., when the client or server is through with it, the list of top touched objects by the current transaction context is traversed and the references to the transaction context for each object is removed. At step 57, the memory management system 50 then traverses all touched objects and destroys all objects with an empty transaction context. Upon destruction of the objects with a transaction context that is empty, these objects are no longer being utilized by any client or server and thus are deleted from memory. The memory management system 50 then exits at step 59.

The foregoing description has been presented for purposes of illustration and description. It is not intended to be exhaustive or to limit the invention to the precise forms disclosed. Modifications or variations are possible in light of the above teachings.

The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A system for providing memory management, comprising:
means for acquiring a first object to perform a service;
means for creating a transaction context to track all referenced objects; and
means for modifying the transaction context each time a next object is referenced.

2. The system of claim 1, wherein said means for modifying further comprises:
means for modifying the transaction context each time the next object is directly referenced.

3. The system of claim 2, wherein said means for modifying further comprises:
means for modifying the transaction context each time the next object is indirectly referenced.

4. The system of claim 3, further comprising:
means for deleting the reference in the transaction context for the first object when the first object is done.

5. The system of claim 4, further comprising:
means for destroying all objects with an empty transaction context.

6. A method for providing memory management, said method comprising the steps of:
acquiring a first object to perform a service;
creating a transaction context to track all referenced objects; and
modifying the transaction context each time a next object is referenced.

7. The method of claim 6, wherein modifying the transaction context step further comprises:
modifying the transaction context each time the next object is directly referenced.

8. The method of claim 7, wherein modifying the transaction context step further comprises:
modifying the transaction context each time the next object is indirectly referenced.

9. The method of claim 8, further comprising the step of:
deleting the reference in the transaction context for the first object when the first object is done.

10. The method of claim 9, further comprising the step of:
destroying all objects with an empty transaction context.

11. A computer readable medium for providing memory management, comprising:
logic that acquires a first object to perform a service;
logic that creates a transaction context to track all referenced objects; and
logic that modifies the transaction context each time a next object is referenced.

12. The computer readable medium of claim 11, further comprising:
logic that modifies the transaction context each time the next object is directly referenced.

13. The computer readable medium of claim 12, further comprising:
logic that modifies the transaction context each time the next object is indirectly referenced.

14. The computer readable medium of claim 13, further comprising:
logic that deletes the reference in the transaction context for the first object when the first object is done.

15. The computer readable medium of claim 14, further comprising:
logic that destroys all objects with an empty transaction context.

16. A system for providing memory management, comprising:
a first object to perform a service;
a transaction context created for the first object to track all referenced objects; and
a modifier that modifies the transaction context each time a next object is referenced.

17. The system of claim 16, wherein said modifier modifies the transaction context each time the next object is directly referenced.

18. The system of claim 17, wherein said modifier modifies the transaction context each time the next object is indirectly referenced.

19. The system of claim 18, further comprising:
a cleanup logic that deletes the reference in the transaction context for the first object when the first object is done.

20. The system of claim 19, further comprising:
a destroy logic that destroys all objects with an empty transaction context.
